(19) United States
(12) Patent Application Publication
(10) Pub. No.: US 2014/0056536 A1
(43) Pub. Date: Feb. 27, 2014

(54) METHOD AND SYSTEM FOR SUBSTANTIALLY REMOVING DOT NOISE

(71) Applicants: Alexander ZAMYATIN, HAWTHORN WOODS, IL (US); Mihail Petru DINU, MUNDELEIN, IL (US); Zhi YANG, VERNON HILLS, IL (US)

(72) Inventors: Alexander ZAMYATIN, HAWTHORN WOODS, IL (US); Mihail Petru DINU, MUNDELEIN, IL (US); Zhi YANG, VERNON HILLS, IL (US)

(73) Assignees: TOSHIBA MEDICAL SYSTEMS CORPORATION, OTAWARA-SHI (JP); KABUSHIKI KAISHA TOSHIBA, TOKYO (JP)

(21) Appl. No.: 13/595,631

(22) Filed: Aug. 27, 2012

(51) Int. Cl. G06K 9/40

(52) U.S. Cl. 382/260; 382/275

(57) ABSTRACT

One technique performs noise removal substantially removing dot noise based upon pseudo-standard deviation (PSD). Another technique performs noise removal including the substantial removal of dot noise based upon Z-score with a punctured approach. The techniques are not limited to particular kernels and include both uniform and non-uniform kernels.

### FIELD OF THE INVENTION

The current invention generally relates to an image processing method and system for substantially removing dot noise that is the remaining noise after some noise reduction processing in images of various modalities.

### BACKGROUND OF THE INVENTION

Dot noise is undesirably visible in the processed images. Dot noise usually is not always an outstanding single pixel, but includes a cluster of a small number of pixels that have noise values. In general, dot noise visually resembles salt-pepper noise and speckle noise, but dot noise is generated from a different origin.

Mostly, dot noise undesirably results from imperfect noise reduction. Due to predefined criteria, some outstanding noise peaks may be mistreated as signals and are either preserved or even enhanced. For these reasons, some outstanding noise peaks become more apparent in the noise reduced image than in an unprocessed image where they reside in a mass of other noisy pixels.

Dot noise is not easily removed by using conventional noise removing techniques such as a medial filter and a smoothing filter. One exemplary prior art noise removing technique is z-score method for detecting signal and removing outlier. Although z-score method may work on certain types of image noise such as salt-pepper noise and speckle noise, the use of Z-score alone may not be effective to dot noise removal.

In view of the prior art dot noise removal techniques, a method and a system of reliably removing dot noise is still desired.

### BRIEF DESCRIPTION OF THE DRAWINGS

FIG. 1 is a diagram illustrating one embodiment of the multi-slice X-ray CT apparatus or scanner according to the current invention.

FIG. 2 is a diagram illustrating some exemplary components in one embodiment of the noise removal device according to the current invention.

FIG. 3 is a diagram illustrating an overall flow of one exemplary process of determining a pseudo standard deviation (PSD) value in an embodiment of the noise removal device according to the current invention.

FIG. 4A is a flow chart illustrating some more details of certain steps of the exemplary process that is performed by the embodiment of the noise removal device according to the current invention.

FIG. 4B illustrates an image that is split into disjoint blocks, as D1 is one of the blocks.

FIG. 5 is a flow chart illustrating steps involved in another particular exemplary process using a pseudo standard deviation (PSD) approach for substantially removing noise including dot noise according the current invention.

FIG. 6 is a flow chart illustrating steps involved in one particular exemplary process using a Z-score based a predetermined punctured approach for substantially removing noise including dot noise according the current invention.

FIG. 7A illustrates an image before any noise removal.

FIG. 7B illustrates an image after the exemplary process using the pseudo standard deviation (PSD) approach according to the current invention.

FIG. 8A illustrates an image before any noise removal.

FIG. 8B illustrates an image after the exemplary process using the punctured standard deviation (SD) approach according to the current invention.

### DETAILED DESCRIPTION OF THE PREFERRED EMBODIMENT(S)

According to one embodiment of the current invention, one technique performs noise removal on signals based upon pseudo-standard deviation (PSD). The embodiment of the current inventions performs noise removal on signals based upon Z-score. In general, the current invention includes both uniform and non-uniform kernels.

For the non-uniform kernels, the only requirement is that the sum of all elements is one. For example, non-uniform kernels include Gaussian kernel, triangle kernel, trapezoidal kernel, Hann kernel, Humming kernel, etc. Non-uniform kernels in which values of the elements are optionally selected based on their application needs.

The use of processed data has some practical advantages over the measured data according to some aspects of the current invention. Since the processed data such as images generally have pixel values and are not limited by the input devices such as detectors, the image data are more general and versatile than the measured data. At least for these reasons, the use of the processed data in the image domain is advantageous in implementing a fully automatic and functionally simple noise removal method. On the other hand, the current invention is not limited to using the processed data or the image data and is implemented using the measured data or the projection data.

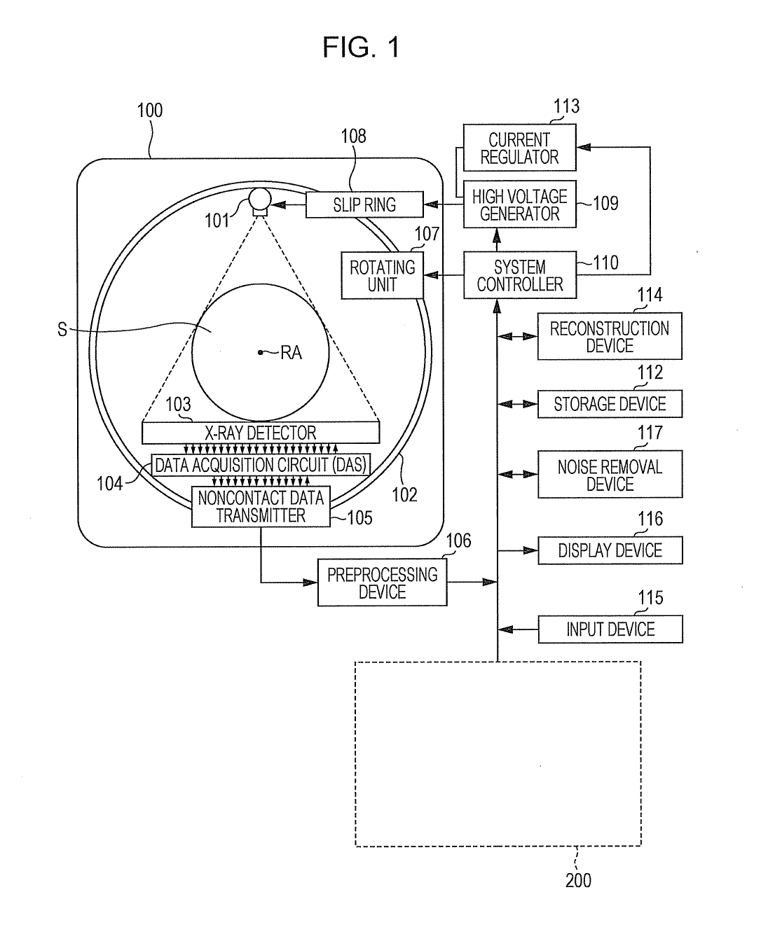

Referring now to the drawings, wherein like reference numerals designate corresponding structures throughout the views, and referring in particular to FIG. 1, a diagram illustrates one embodiment of the multi-slice X-ray CT apparatus or scanner according to the current invention including a gantry 100 and other devices or units. The gantry 100 is illustrated from a front view and further includes an X-ray tube 101, an annular frame 102 and a multi-row or two-dimensional array type X-ray detector 103. The X-ray tube 101 and X-ray detector 103 are diametrically mounted across a subject S on the annular frame 102, which rotates around axis RA. A rotating unit 107 rotates the frame 102 at a high speed such as 0.4 sec/rotation while the subject S is being moved along the axis RA into or out of the illustrated page.

The multi-slice X-ray CT apparatus further includes a current regulator 113 and a high voltage generator 109 that applies a tube voltage to the X-ray tube 101 so that the X-ray tube 101 generates X ray. In one embodiment, the high voltage generator 109 is mounted on the frame 102. The X rays are emitted towards the subject S, whose cross sectional area is represented by a circle. The X-ray detector 103 is located at an opposite side from the X-ray tube 101 across the subject S for detecting the emitted X rays that have transmitted through the subject S.

Still referring to FIG. 1, the X-ray CT apparatus or scanner further includes other devices for processing the detected signals from X-ray detector 103. A data acquisition circuit or a Data Acquisition System (DAS) 104 converts a signal output from the X-ray detector 103 for each channel into a voltage signal, amplifies it, and further converts it into a digital signal. The X-ray detector 103 and the DAS 104 are configured to handle a predetermined total number of projections per rotation (TPPR).

The above described data is sent to a preprocessing device 106, which is housed in a console outside the gantry 100 through a non-contact data transmitter 105. The preprocessing device 106 performs certain corrections such as sensitivity correction on the raw data. A storage device 112 then stores the resultant data that is also called projection data at a stage immediately before reconstruction processing. The storage device 112 is connected to a system controller 110 through a data/control bus, together with a reconstruction device 114, a display device 116, an input device 115, and a scan plan support apparatus 200. The scan plan support apparatus 200 includes a function for supporting an imaging technician to develop a scan plan.

One embodiment of the current invention further includes a combination of various software modules and hardware components for implementing a noise removal device 117. In the current application, the noise removal device 117 performs predetermined functions for noise removal including dot noise removal, and the functions are associated with determining a noise index such as pseudo-standard deviation (PSD) or Z-score, comparing the noise index and adjusting the pixel values if necessary. Either one of PSD and Z-score of a given pixel is used as a noise index to determine as to whether or not the pixel value needs to be adjusted. PSD and Z-score will be further described in the current application with respect to the noise removal techniques according to the current invention.

The noise removal device 117 is connected to the reconstruction device 114 and the storage device 112 via the data/control bus. The reconstruction device 114 reconstructs an image or generates image data based upon the projection data that is optionally stored in the storage device 112. The projection data is generated from measured data via the data acquisition circuit or the Data Acquisition System (DAS) 104 and the processing device 106. The measured data or signals in turn are detected at the X-ray detector 103. For the purpose of the current application, the term, data such as in image data and measured data is interchangeably used with the term signal such as in image signal and measured signal. The term, signal itself broadly includes both image data and measured data.

In one embodiment, the noise removal device 117 receives the reconstructed image data from the reconstruction device 114 and or the storage device 112 in order to perform the tasks on the image data for substantially removing noise such as dot noise by adjusting pixel values. As described above, since the reconstructed image is in the image domain after reconstruction, the noise removal device 117 is advantageously free from additional processing or limitations that are necessary for further processing measured data in a noise index determination.

In another embodiment, the noise removal device 117 receives the measured data from the reconstruction device 114 and or the storage device 112 in order to perform the tasks on the measured data for determining the PSD as a noise index. As described above, since the measured data is in the data domain before reconstruction, the noise removal device 117 is not necessarily free from additional processing or limitations for further processing the measured data in the noise index determination.

In either embodiment, the noise removal device 117 performs a predetermined set of tasks on the received signals in determining a noise index such as PSD and calculates the associated Z-score. The automatic process or method is optionally controlled according to a predetermined set of parameters such as a threshold value or a scaling factor for removing undesirable noise such as dot noise. Furthermore, the parameters also include a size or characteristics of a kernel for filtering the signals or data in determining PSD as a noise index. The above described parameters are illustrative only and are not limited to the enumerated specific examples.

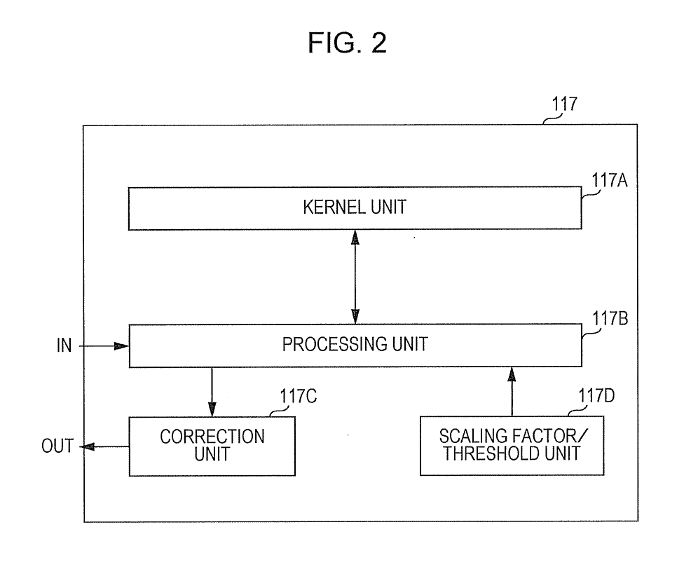

Now referring to FIG. 2, a diagram illustrates some exemplary components in one embodiment of the noise removal device 117 according to the current invention. The noise removal device 117 includes a kernel unit 117A, a processing unit 117B, a correction unit 117C and a scaling factor/threshold unit 117D. Depending upon a particular noise index, the noise removal device 117 optionally uses slightly different functions and or predetermined values. For example, the noise removal device 117 determines a pseudo standard deviation (PSD) value as a noise index for a given pixel. In determining a PSD, the processing unit 117B receives image data through a particular data port IN and generates an approximate data or filtered data using a predetermined kernel in the kernel unit 117A. In case of an exemplary PSD determination technique, the approximated data is a mean value from 3×3×3 pixel data using a convolution kernel. The processing unit 117B determines a difference Vdiff between the mean and a particular pixel value. The processing unit 117B further processes the above processed data to generate a PSD value or PSD(x,y) for a given pixel (x, y) as will be further described in detail. After the kernel unit 117A scales the PSD value for a pixel at x, y according to a predetermined scaling factor r in the scaling factor/threshold unit 117D, the processing unit 117B compares the scaled product to the corresponding value of the difference Vdiff (x, y) for the pixel at (x, y). Depending upon the comparison result, the correction unit 117C outputs either the original pixel value at x, y or the mean value associated with the pixel at x,y in one exemplary embodiment. Although these exemplary components, modules or units are implemented in a combination of software and hardware, the noise removal device 117 is not limited to these particular components, modules or units according to the current invention.

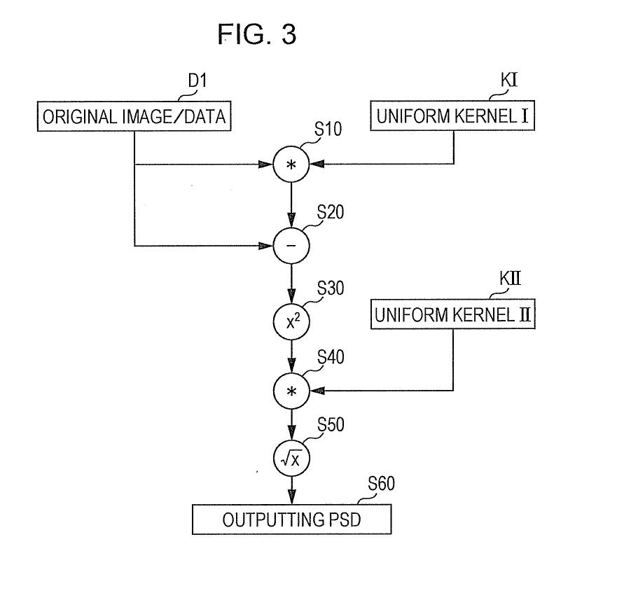

Now referring to FIG. 3, a diagram illustrates an overall flow of one exemplary process of determining a PSD value in an embodiment of the noise removal device 117 according to the current invention. In a step S10, original signal D1 is smoothed by convolving as denoted by an asterisk with a predetermined uniform kernel KI. The original signal is either measured data or image data. One example of the kernel KI is a square kernel such as N×N while another example of the kernel KI is a rectangular kernel such as N×M, where both N and M are an integer. The result of the convolution in the step S10 is now the smoothed or approximated signal. In a step S20, a difference is determined as denoted by a minus sign between the corresponding one of the approximated signals from the step S10 and the original signals D1.

Still referring to FIG. 3, the embodiment of the noise removal device 117 according to the current invention further performs the additional tasks in one exemplary process according to the current invention. In a step S30, the difference as determined in the step S20 is now squared as denoted by x². In a step S40, the squared result from the step S30 is now again smoothed or approximated by convolving as denoted by an asterisk with a predetermined uniform kernel KII to generate the second smoothed result. One example of the kernel KII is a square kernel such as P×P while another example of the kernel KII is a rectangular kernel such as P×Q, where both P and Q are an integer. The kernels KI and KII are optionally the same in one embodiment while they are different in another embodiment. Furthermore, the kernels KI and KII are optionally a predetermined combination of uniform and non-uniform kernel. In a step S50, a square root value of the second smoothed result from the step S40 is now calculated as denoted by a square-root sign. Now PSD has been obtained in the step S50 for a particular pixel neighborhood. In a step S60, the PSD is outputted for further comparison.

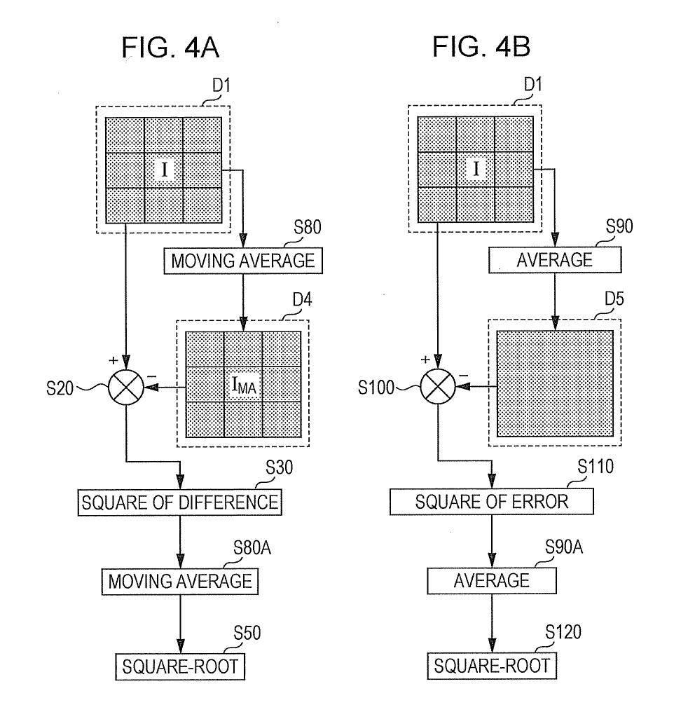

Now referring to FIG. 4A, a flow chart illustrates some more details of certain steps of the exemplary process for PSD calculation that is performed by the embodiment of the noise removal device 117 according to the current invention. Generally, noise is originated from multiple sources including but not limited to quantum noise in photo count, electronic noise in a data acquisition system (DAS), quantization noise in analog-to-digital conversion (A/D) and approximation during reconstruction. Assuming that the I(x, y) represents an image that has been corrupted by some additive noise, the image data I(x, y) is expressed by the following Equation (1).

I(x,y)=I₀(x,y)+n(x,y) (1)

where I₀ is an original data or true signal and n is noise that has been added to the original image due to various sources. x and y are the 2D coordinates of a pixel. The steps involved in the flow chart of FIG. 4A are summarized in Equation (2) to determine a noise index PSD.

$$P S D ( x , y ) = \sqrt{w ( u , v ) ⊗ {[ I ( x , y ) - w ( u , v ) ⊗ I ( x , y ) ]}^{2}} \qquad ( 2 )$$

where [symbol] represents convolution operator and w(u, v) is a normalized uniform moving average kernel. The moving average inside brackets calculates the mean value of each pixel neighborhood while the one outside the brackets calculates the neighborhood averages of the mean-square-errors (MSE). Notice that the MSEs are calculated by subtracting the filtered samples instead of subtracting the single average value of the samples as standard deviation formulas normally do. The PSD approaches the “true” standard deviation when the assumptions to (1) are valid. PSD is used to improve computational efficiency of direct calculation of standard deviation (SD). Furthermore, to assure accurate noise assessment, multiple passes of above procedure are optionally performed in certain exemplary methods and systems of the current invention.

Still referring to FIG. 4A, in a step S80, the original image I is smoothed by taking a moving average of the image. That is, a normalized uniform moving average kernel of a predetermined size has been applied. The dotted line indicates an extent of the image outside the neighborhood while the solid line indicates a typical local pixel neighborhood. In this regard, the local pixel neighborhood of D1 in this example is a 3×3 neighborhood containing 9 pixels. By taking moving average over the image I, a new image I_{MA} is created, in which the value of each pixel are the average of its 3×3 neighborhood. For the particular neighborhood D1, corresponding moving average result is D4. As already described with respect to FIG. 3, the result of convolution with a normalized uniform kernel in the step S80 is now a neighborhood-averaging of the image at each pixel. In step S20, a difference is determined as denoted by a minus sign between the corresponding one of the values in D4 from the step S80 and the original signals D1. Furthermore, in a step S30, the difference is squared. In step S80A, neighborhood-average of the squared difference is computed by applying the normalized uniform moving average kernel. Finally, a square root of the result from the step S80A is determined in a step S50. Thus, pseudo standard deviation (PSD) for each pixel in the image has been determined. The normalized uniform moving average kernel in the step S80 and S80A is optionally the same in one method while it is different in another method.

In contrast, referring to FIG. 4B, image I is split into disjoint blocks, as D1 is one of the blocks. In a step S90, block average of D1 is calculated. The average value is assigned to all 3×3 neighborhood in D5. In a step 100, a difference or an error is determined as denoted by a minus sign between the average signals from the step S90 and the original signals D1. Furthermore, in a step S110, the error is squared. In step S90A, block-average of the squared difference is computed. Finally, a square root of the result from the step S90A is determined in a step S120. Thus, normal standard deviation (SD) has been determined.

In summary, the advantage of using the PSD over the normal SD is that PSD may reflect noise SD more accurately by not taking the edge variation as part of the standard deviation component. The PSD approaches the SD in the regions where image has constant or slow varying mean values.

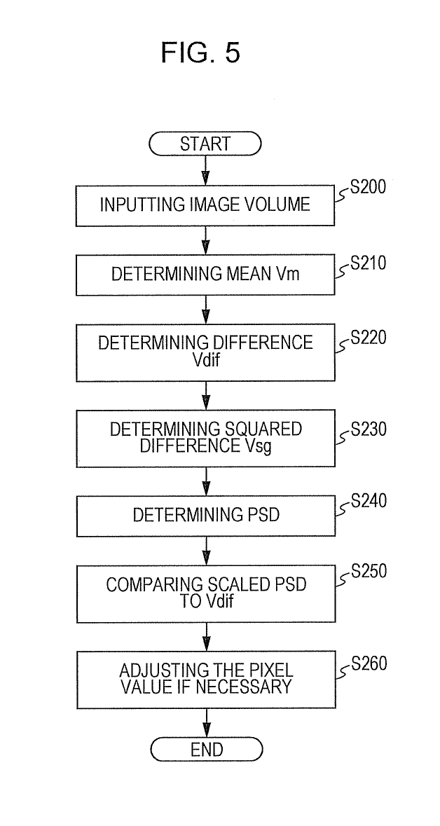

Now referring to FIG. 5, a flow chart illustrates steps involved in another particular exemplary process using a pseudo standard deviation (PSD) approach for substantially removing noise including dot noise according the current invention. In general, the PSD is less affected by edge pixels than standard deviation (SD).

Dot noise is usually not a single outstanding pixel. In this regard, dot noise is often a cluster or a small number of pixels. By selecting a proper size of neighborhood, the dot noise pixels become sufficiently identifiable as outstanding pixels. After identifying the dot noise pixels, the dot noise pixels are optionally reset to the predetermined local mean value. As a result, only the outliers of the dot noise pixels are modified and other pixel values are unchanged.

According to one exemplary process using a PSD approach for substantially removing noise including dot noise according the current invention, one implemented procedure includes the following steps. In a step S200, image volume V is inputted to be processed, and the inputted image volume is often not free from noise including dot noise. In a first implementation of a step S210, mean image volume Vm is determined based upon a predetermined convolution kernel h of a size such as 3×3×3 pixels as defined in the following equation.

Vm=V [symbol] h (3)

In the first implementation of a step S220, a difference image Vdiff is determined by subtracting the mean image volume Vm from a corresponding potion of the image volume V in the following equation.

Vdif=V−Vm (4)

The above determined difference image Vdiff is squared to generate squared difference image Vsq in a step S230 in the following equation.

Vsq=Vdif² (5)

A PSD value is determined by taking a root square after the squared difference image Vsq is convoluted again with a predetermined convolution kernel h in a step S240 in the following equation.

$$P S D = \sqrt{Vsq ⊗ h} \qquad ( 5 )$$

The predetermined convolution kernel h in the step S240 is optionally the same as the predetermined convolution kernel h in the step S210 in a certain implementation. Alternatively, the predetermined convolution kernel h in the step S240 is optionally different from the predetermined convolution kernel h in the step S210 in another implementation. The PSD value is thus determined for a pixel at (x, y).

The above determined PSD value is scaled by a predetermined threshold value r to generate rPSD, and the scaled rPSD value is compared to a corresponding difference image Vdiff in a step S250. The predetermined threshold value r is specifically determined for substantially identifying dot noise rather than general noise. One exemplary predetermined threshold value r is 2 for substantially identifying dot noise. If the scaled rPSD value for a pixel at (x, y) is larger than the corresponding difference image Vdiff, the corresponding mean image volume Vm at the pixel (x, y) is outputted in a step S260. On the other hand, if the scaled rPSD value is equal to or smaller than the corresponding difference image Vdiff, the image volume V at the pixel (x, y) is outputted in the step S260.

The above described particular implementations are merely exemplary, and the current invention is not necessarily limited by the exact manner or steps as disclosed. For example, the PSD approach and the punctured approach are each optionally modified or combined with another approach or with each other.

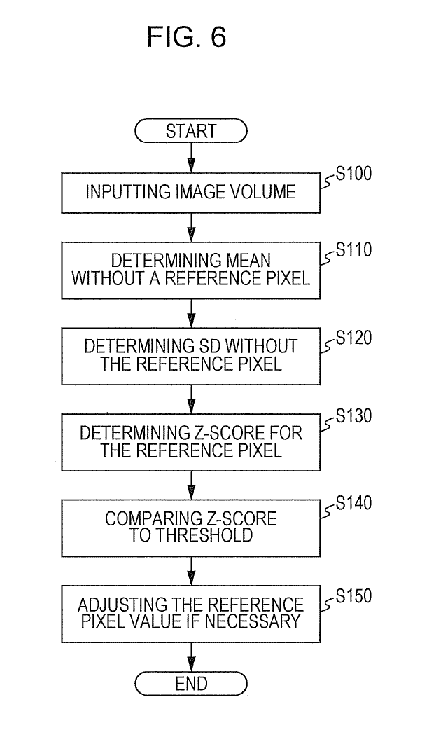

Now referring to FIG. 6, a flow chart illustrates steps involved in one particular exemplary process using a Z-score based punctured approach for substantially removing noise including dot noise according the current invention. In general, the punctured approach processes a central pixel in a selected block of pixels in a different manner. Because of the uniquely processed central pixel value, one exemplary process of the punctured approach is different from a known Z-score approach by excluding the central pixel value in determining a Z-score value for separating outliers. The Z-score is typically defined by following formula:

z=(x−μ)/σ (6)

where x is the center pixel of a pixel neighborhood, is the mean of the neighborhood, and σ is the standard deviation (SD). It is determined as to whether or not the pixel value x is within a normal range by comparing the Z-score value of x to a preset ratio or threshold value (R) such as 2. If the Z-score value of x is below the preset ratio or threshold value (R) such as 2, the pixel x is not considered as an outlier and thus is not a noise pixel. On the other hand, if the Z-score value of x is outside of the a preset ratio or threshold value (R) such as 2, the pixel x is considered as an outlier and thus is some noise such as dot noise if the R is 2.

Dot noise is usually not a single outstanding pixel. In this regard, dot noise is often a cluster or a small number of pixels. By selecting a proper size of neighborhood, the dot noise pixels become sufficiently identifiable as outstanding pixels. After identifying the dot noise pixels, the dot noise pixels are optionally reset to the predetermined local mean value. As a result, only the outliers as dot noise pixels are modified and other pixel values are unchanged.

According to one exemplary process using a Z-score based the punctured approach for substantially removing noise including dot noise according the current invention, a center pixel is excluded in calculating a local mean value and a PSD in order to avoid the effect of a possible outlier to the mean and or SD calculation. In some details, one implemented procedure includes the following steps. In a step S100, image volume V is inputted to be processed, and the inputted image volume is often not free from noise including dot noise.

In a first implementation of a step S110, mean image volume Vm is determined based upon a predetermined mask size such as 3×3×3 pixels without using a central or reference pixel value in the predetermined mask. In other words, the predetermined mask selects neighborhood pixels. In the first implementation of the step S120, standard deviation σ is determined using the pixels in the selected neighborhood without using the central or reference pixel value. Based upon the above determined mean Vm and the standard deviation σ, a Z-score is determined for the central or reference pixel in the selected neighborhood according to Equation (6) in the first implementation of a step S130. The Z-score for the central or reference pixel is compared to a predetermined threshold value r in a step S140. The predetermined threshold value r is specifically determined for substantially identifying dot noise rather than general noise. One exemplary predetermined threshold value r is 2 for substantially identifying dot noise. If the Z-score for the central or reference pixel is larger than the predetermined threshold value, the central or reference pixel value is replaced by the mean value Vm in a step S150. On the other hand, if the Z-score for the central or reference pixel is equal to or smaller than the predetermined threshold value, the central or reference pixel value is unchanged in the step S150.

In another implementation, the punctured approach is used with PSD. In this implementation, convolution becomes explicit iterative calculations pixel by pixel. Since the kernel size is not large, the above calculation does not appear to increase the computational cost in a significant manner. For uniform kernel h, Equations (3) through (5) are optionally modified by extracting neighborhood of V so that V2=V̂2.

Vm=mean (extracted neighborhood), ignoring a center pixel of the neighborhood;

Vm2=Vm̂2;

V2m=mean (extracted neighborhood of V2), ignoring a center pixel;

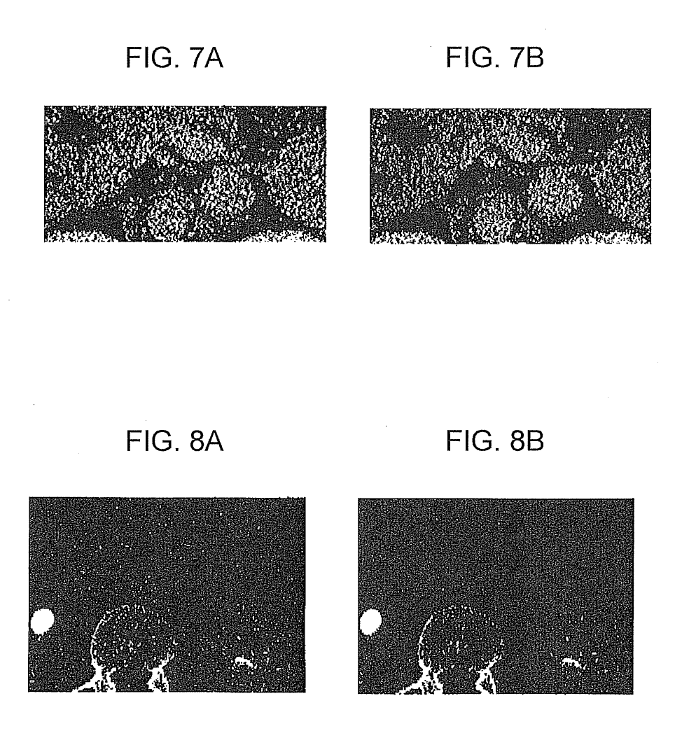

Now referring to FIGS. 7A and 7B illustrate some effect of an exemplary process using a pseudo standard deviation (PSD) approach for substantially removing noise including dot noise according the current invention. FIG. 7A illustrates an image before any noise removal while FIG. 7B illustrates an image after the exemplary process using the pseudo standard deviation (PSD) approach.

Now referring to FIGS. 8A and 8B illustrate some effect of an exemplary process using a punctured standard deviation (SD) approach for substantially removing noise including dot noise according the current invention. FIG. 8A illustrates an image before any noise removal while FIG. 8B illustrates an image after the exemplary process using the punctured standard deviation (SD) approach.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of reducing noise in image data representing pixels, comprising the steps of:
a) obtaining filtered data based upon the image data and a predetermined convolution kernel;
b) obtaining difference data between the image data and the filtered data;
c) determining squared difference data from the difference data; and
d) obtaining pseudo standard deviation data based on the squared difference data and the predetermined convolution kernel;
e) scaling the pseudo standard deviation data by a predetermined value; and
f) identifying pixels with noise in the image data by comparing the difference data and the scaled pseudo standard deviation data; and
g) correcting the image data at the identified pixels.

2. The method of reducing noise in image data representing pixels according to claim 1 wherein the steps a) through g) are repeated for each image in the image data.

3. The method of reducing noise in image data representing pixels according to claim 1 wherein the predetermined value is approximately between 2 and 3.

4. The method of reducing noise in image data representing pixels according to claim 1 wherein the image data is corrected by replacing the identified pixels with the filtered data.

5. The method of reducing noise in image data representing pixels according to claim 1 wherein the image data is corrected by replacing the identified pixels with order statistics values including median values.

6. The method of reducing noise in image data representing pixels according to claim 1 wherein the steps a) through g) are iteratively repeated.

7. The method of reducing noise in image data representing pixels according to claim 1 wherein the noise includes dot noise.

8. A method of reducing noise in image data having pixels, comprising the steps of:
a) obtaining a mean value for a reference pixel based upon neighboring pixels without using a reference pixel value;
b) obtaining one of a pseudo-standard deviation value and a standard deviation value for the reference pixel based upon the neighboring pixels without using the reference pixel value;
c) determining a Z-score value for the reference pixel based upon the mean value and one of the pseudo-standard deviation value and the standard deviation value;
d) comparing the Z-score value against a predetermined Z-score threshold value to detect noise; and
e) correcting the reference pixel value if the noise is detected.

9. The method of reducing noise in image data having pixels according to claim 8 wherein the predetermined Z-score threshold value is approximately between 2 and 3.

10. The method of reducing noise in image data having pixels according to claim 8 wherein the steps a) through e) are repeated for each of the pixels.

11. The method of reducing noise in image data having pixels according to claim 10 wherein the steps a) through e) are iteratively repeated.

12. The method of reducing noise in image data having pixels according to claim 8 wherein the reference pixel value is corrected by replacing the reference pixel value with the mean value.

13. The method of reducing noise in image data having pixels according to claim 8 wherein the reference pixel value is corrected by replacing the reference pixel value with an order statistics value including a median value.

14. The method of reducing noise in image data having pixels according to claim 8 wherein the neighboring pixels are adaptively selected.

15. The method of reducing noise in image data having pixels according to claim 8 wherein the neighboring pixels are predetermined.

16. The method of reducing noise in image data having pixels according to claim 8 wherein the noise includes dot noise.

17. A system for reducing noise in image data representing pixels, comprising:
a kernel unit having a predetermined convolution kernel;
a processing unit connected to said kernel unit for obtaining filtered data based upon the image data and the predetermined convolution kernel in said kernel unit, said processing unit obtaining difference data between the image data and the filtered data, said processing unit determining squared difference data from the difference data; and said processing unit obtaining pseudo standard deviation data based on the squared difference data and the predetermined convolution kernel, said processing unit scaling the pseudo standard deviation data by a predetermined scaling factor, said processing unit identifying pixels with noise in the image data by comparing the difference data and the scaled pseudo standard deviation data; and
a correction unit connected to said processing unit for correcting the image data at the identified pixels.

18. The system for reducing noise in image data representing pixels according to claim 17 wherein said processing unit and said correction unit repeatedly perform on each image in the image data.

19. The system for reducing noise in image data representing pixels according to claim 17 wherein the predetermined scaling factor is approximately between 2 and 3.

20. The system for reducing noise in image data representing pixels according to claim 17 wherein said correction unit corrects the image data by replacing the identified pixels with the filtered data.

21. The system for reducing noise in image data representing pixels according to claim 17 wherein said correction unit corrects the image data by replacing the identified pixels with order statistics values including median values.

22. The system for reducing noise in image data representing pixels according to claim 17 wherein said processing unit and said correction unit iterate.

23. The system for reducing noise in image data representing pixels according to claim 17 wherein the noise includes dot noise.

24. A system for reducing noise in image data having pixels, comprising:
a processing unit obtaining a mean value for a reference pixel based upon neighboring pixels without using a reference pixel value, said processing unit obtaining a standard deviation value for the reference pixel based upon the neighboring pixels without using the reference pixel value, said processing unit determining a Z-score value for the reference pixel based upon the mean value and the standard deviation value, said processing unit comparing the Z-score value against a predetermined Z-score threshold value to detect noise; and
a correction unit connected to said processing unit for correcting the reference pixel value if the noise is detected.

25. The system for reducing noise in image data having pixels according to claim 24 wherein the predetermined Z-score threshold value is approximately between 2 and 3.

26. The system for reducing noise in image data having pixels according to claim 24 wherein said processing unit and said correction unit repeat processing for each of the pixels.

27. The system for reducing noise in image data having pixels according to claim 26 wherein said processing unit and said correction unit iterate.

28. The system for reducing noise in image data having pixels according to claim 24 wherein said correction unit corrects the reference pixel value by replacing the reference pixel value with the mean value.

29. The system for reducing noise in image data having pixels according to claim 24 wherein said correction unit corrects the reference pixel value by replacing the reference pixel value with an order statistics value including a median value.

30. The system for reducing noise in image data having pixels according to claim 24 wherein said processing unit adaptively selects the neighboring pixels.

31. The system for reducing noise in image data having pixels according to claim 24 wherein the neighboring pixels are predetermined.

32. The system for reducing noise in image data having pixels according to claim 24 wherein the noise includes dot noise.
